(19) United States
(12) Patent Application Publication
(10) Pub. No.: US 2011/0316407 A1
(43) Pub. Date: Dec. 29, 2011

(54) STRUCTURE OF LED (LIGHT-EMITTING DIODE) LIGHTING BULB

(75) Inventors: Ching Feng Lin, Taipei County (TW); Yung Han, Taipei County (TW)

(73) Assignee: JADE YANG CO., LTD., Taipei County (TW)

(21) Appl. No.: 12/960,687

(22) Filed: Dec. 6, 2010

(30) Foreign Application Priority Data
Jun. 24, 2010 (TW) 099212031

(51) Int. Cl. H01J 61/52; H01J 5/50

(52) U.S. Cl. 313/46; 313/318.01

(57) ABSTRACT

An LED (Light-Emitting Diode) lighting bulb includes an electrical connector, a base, a circuit board, and a cover. The electrical connector is recessed to form a hollow configuration having an intermediate section forming threading. The base is formed by molding a moldable material.

The base has a lower end forming a neck portion that has an outer circumferential surface forming threading for being fit to the electrical connector and an upper end to which the circuit board is mounted. The circuit board carries an LED thereon. The cover is formed by molding a moldable material and is mounted to the base. As such, an LED lighting bulb showing the advantages of reduced weight, reduced power consumption, improved heat dissipation performance, multiple colors, and excellent operation safety is provided.

### BACKGROUND OF THE INVENTION

1. Field of the Invention

The present invention relates to an improved structure of LED (Light-Emitting Diode) lighting bulb, and more particular to a structure of LED lighting bulb composed of a fin base, a pillar, a circuit board, an electrical connector, and a cover, wherein the pillar and the circuit board are arranged to be releasably mounted so that when the circuit board is broken or fails to properly function, the circuit board can be easily replaced to ensure ready maintenance, and the structure is applicable to a regular light bulb, a power-saving light bulb, or the similar lighting bulbs.

2. Description of Related Art

A traditional light bulb comprises tungsten filaments for giving off light. A spherical cover of the traditional light bulb is usually made of glass. The longer is the time period that the light bulb is used, the higher is the temperature that the bulb will be. Further, the traditional light bulb consumes a large amount of electrical power and is not environmentally friendly.

The development of science and technology nowadays makes it possible to manufacture lighting bulb with LEDs for substitute of the traditional light bulbs that consume a large amount of electrical energy and are not environmentally friendly. Due to the requirement for heat dissipation of the LED lighting bulbs, heat dissipation fins are provided at locations close to the LEDs and the circuit board thereof in order to fast remove heat therefrom. The heat dissipation fins are often made of aluminum extrusion. This makes the assembly and manufacture complicated. Further, due to being subjected to heating, a cover is easily deformed and loses tight engagement with the aluminum extrusions. Further, it is not convenient for recycling.

Since the heat dissipation fins of a base of the LED based lighting bulb are made of aluminum extrusion, in replacing the bulb, if the power supply is not cut off or insulation of the circuit is poor, a potential risk of electricity leakage or electrical shocking may result. Although an insulation enclosure may be added to shield the aluminum base, yet this deteriorates the performance of heat dissipation.

In view of these drawbacks of the conventional lighting, the present invention aims to provide an improved structure of LED lighting bulb that is advantageous in reducing weight, reducing power consumption, improving heat dissipation, providing multiple color variations, and showing excellent operation safety and that allows for improved efficiency of manufacturing and assembling to ensure easy installation for the general users.

### SUMMARY OF THE INVENTION

Accordingly, the primary objective of the present invention is to provide an improved structure of LED (Light-Emitting Diode) lighting bulb , which is composed of an electrical connector, a base, a circuit board, and a cover, wherein the base has an upper end supporting the circuit board and a lower end forming a neck portion that has an outer circumferential surface forming threading for being fit to the electrical connector and the cover is mounted to the base to thereby realize the advantages of easy assembling and reduction of costs and thus enhance the overall practicability.

Another objective of the present invention is to provide an improved structure of LED lighting bulb, which comprises a cover and a base that are integrally formed by molding moldable materials, wherein the base is an insulator that eliminates the potential risk of electricity leakage at a grounding portion of the electrical connector of the LED based lighting bulb and protects a user against electrical shocking due to not cutting off electrical power supply or poor circuit insulation, thereby improving overall operation safety.

A further objective of the present invention is to provide an improved structure of LED lighting bulb, which comprises a base that comprises a plurality of fins that is integrally formed and is circumferentially arranged around the base to improve the performance of heat dissipation to thereby improve lighting performance and practicability.

Yet a further objective of the present invention is to provide an improved structure of LED lighting bulb, which comprises a cover and a base that are integrally formed by molding moldable materials so that the color of the cover can be modified to achieve the advantages of reducing weight and improving colorfulness and thus improving overall convenience.

In order to achieve the above objectives, according to the present invention, an improved structure of LED lighting bulb comprises an electrical connector, a base, a circuit board, and a cover. The electrical connector is recessed to form a hollow configuration having an intermediate section forming threading. The base is integrally formed by molding a moldable material. The base has a lower end forming a neck portion that has an outer circumferential surface forming threading for being fit to the electrical connector and an upper end to which the circuit board is mounted. The circuit board carries an LED thereon. The cover is formed by molding a moldable material and is mounted to the base. As such, an LED lighting bulb showing the advantages of reduced weight, reduced power consumption, improved heat dissipation performance, multiple colors, and excellent operation safety is provided.

### BRIEF DESCRIPTION OF THE DRAWINGS

The present invention can be fully understood from the following detailed description and a preferred embodiment with reference to the accompanying drawings, in which:

FIG. 1 is a perspective view showing an LED (Light-Emitting Diode) lighting bulb according to an embodiment of the present invention;

FIG. 2 is an exploded view of the LED lighting bulb according to the embodiment of present invention;

FIG. 3 is a cross-sectional view showing the LED lighting bulb according to the embodiment of the present invention; and

FIG. 4 is a front view showing a cover of the LED lighting bulb according to the present invention.

### DETAILED DESCRIPTION OF THE PREFERRED EMBODIMENTS

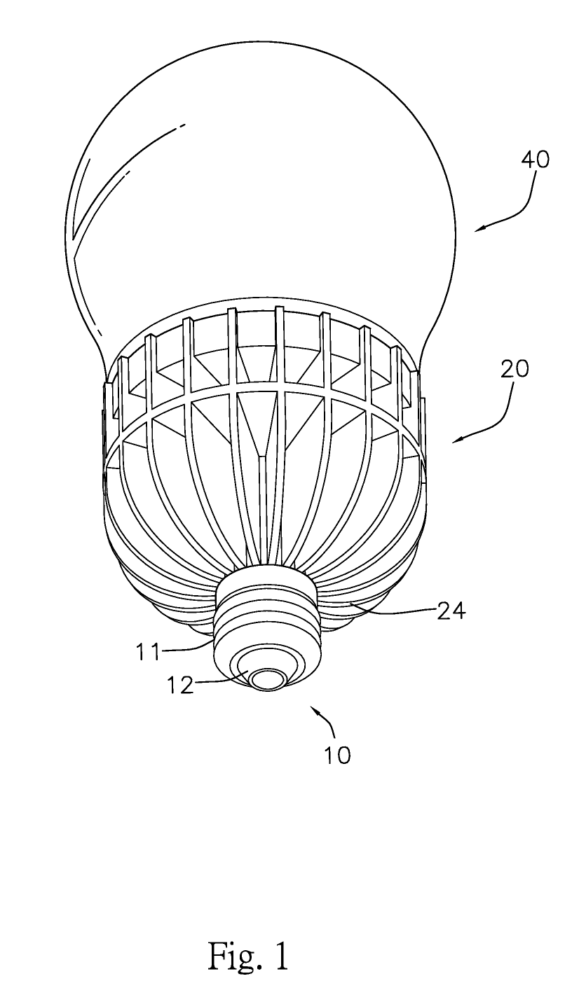

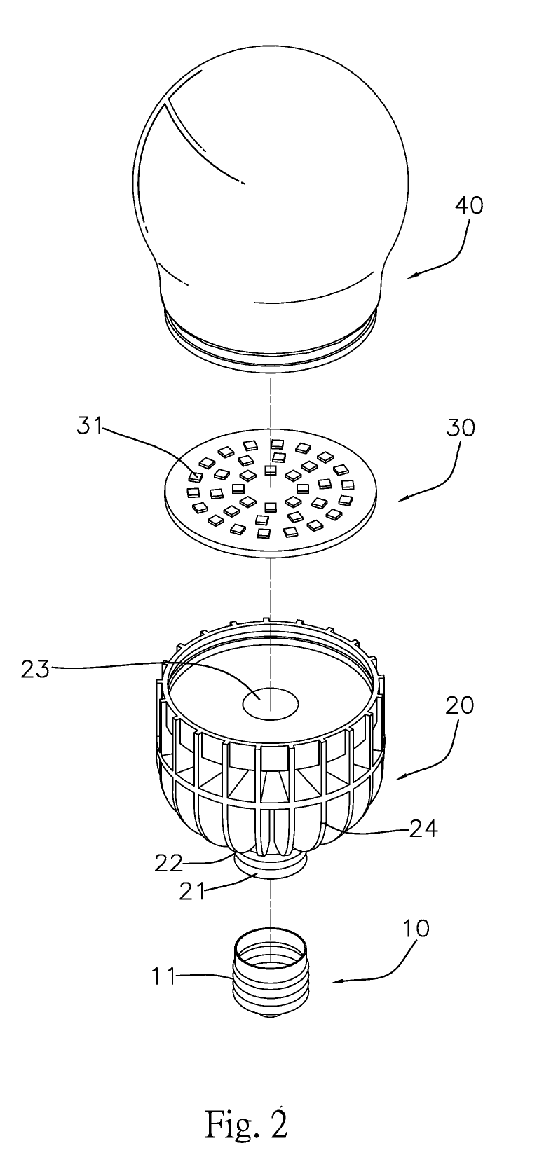

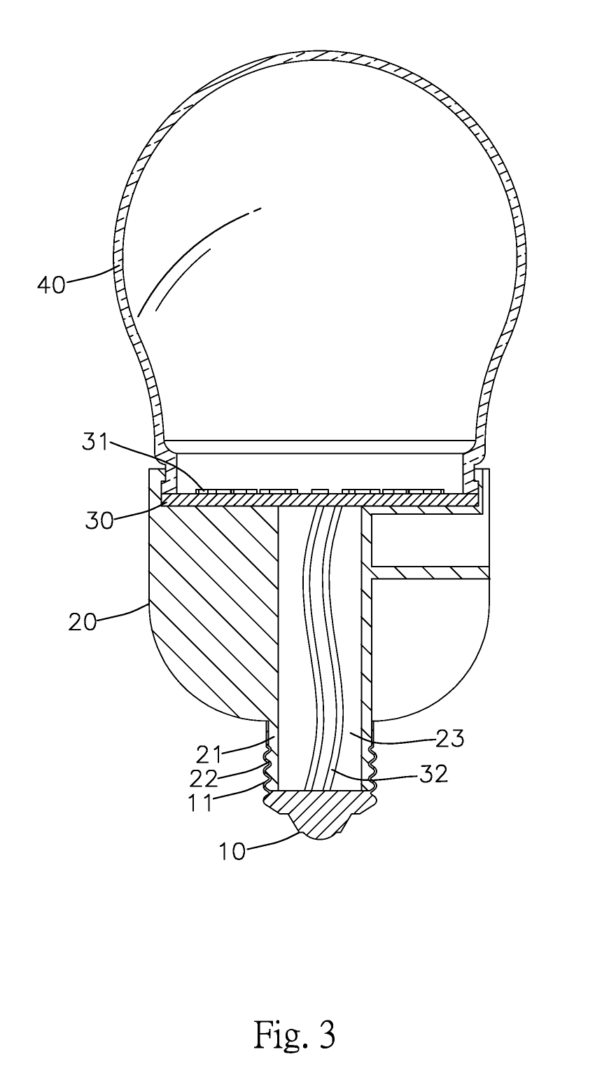

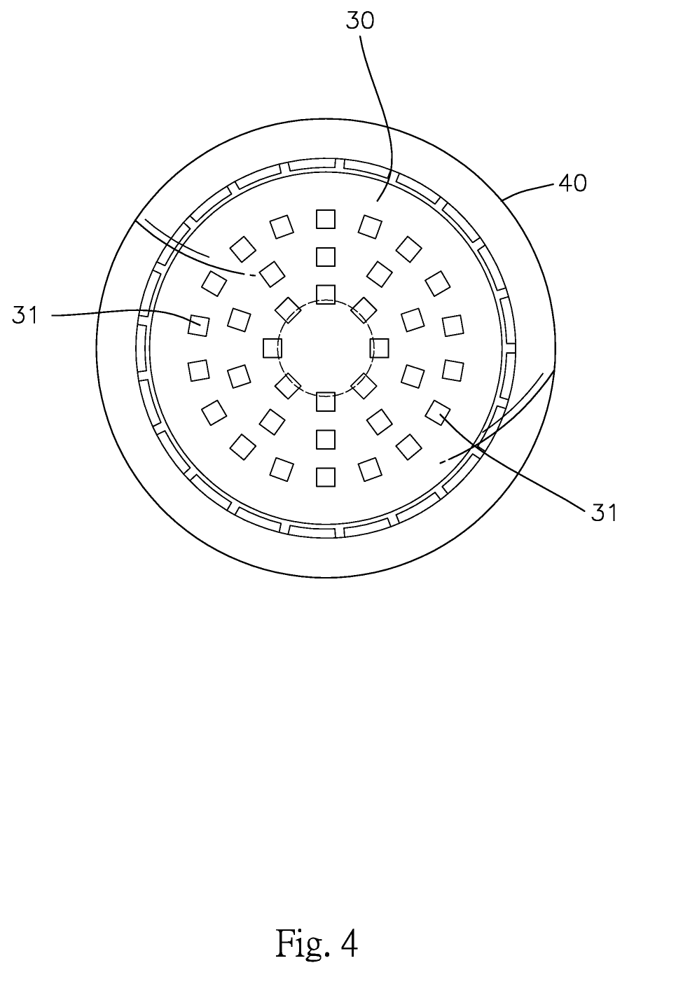

Referring to FIGS. 1-4, an embodiment of the present invention is schematically illustrated. The present invention provides an improved structure of LED (Light-Emitting Diode) lighting bulb, which comprises an electrical connector 10, a base 20, a pillar 20, a circuit board 30, and a cover 40. The electrical connector 10 is recessed to form a hollow configuration having an intermediate section forming threading 11. The base 20 is integrally formed as a molding of moldable material. The base 20 has a lower end forming threading 22 for receiving the electrical connector 10 to fit thereon. The circuit board 30 is mounted to an upper end of the base 20 and the circuit board 30 carries thereon LEDs 31 thereon. The cover 40 is made of a moldable material and the cover 40 is mounted to the base 20 so as to form a weight-reduced LED lighting bulb of vivid color variation.

The cover 40 and the base 20 are made of moldable materials, which are preferably colored for identification and showing. The moldable materials of the cover 40 and the base 20 are preferably plastics. The base 20 further defines a through hole 23 through which conductor wires 32 extend for electrical connection with the connector 10. The base 20 comprises a plurality of fins 24 circumferentially arranged around the base 20 for heat dissipation purposes. The cover 40 is of a spherical configuration to provide a large illumination area. The cover 40 and the base 20 can be coupled to each other through fitting or threading engagement.

Referring to FIGS. 1-4, which show schematically an embodiment according to the present invention, the improved structure of LED lighting bulb according to the present invention is preferably embodied in the form comprising an electrical connector 10, a base 20, a circuit board 30, and a cover 40. The electrical connector 10 is recessed to form a hollow configuration, which has an intermediate section forming threading 11 for coupling to a seat (not shown) through threading engagement and electrically connecting with a power supply source. The electrical connector 10 is made of an electrically conductive material, such as metals. The electrical connector 10 has a lower end that coated with an insulation substance 12 in the form of a ring in order to space positive and negative electrodes of power supply to thereby avoid electrical shorting. The base 20 is integrally formed of a moldable material, which is preferably a plastic material or a similar material, and it is also preferable that coloring agents of different colors are added in injection molding of the moldable material so that the base 2 can match or combine with the color of light emitting from the bulb to show variation of colorful appearance. The base 20 has a lower end forming a neck portion 21 that has an outer circumferential surface forming an external thread 22. The neck portion 21 has a diameter that is smaller than a diameter of the electrical connector 10 to be fit into the electrical connector 10, so that the base 20 is securely fixed to the electrical connector 10 through threading engagement between the threading 11 of the electrical connector 10 and the threading 22 of the neck portion 21. Further, the base 20 comprises a plurality of heat dissipation fins 24 that is formed on a portion above the neck portion 21 and circumferentially arranged around the base 20 for heat dissipation. The fins 24 and the base 20 are formed integrally with each other and the fins 24 can be of different outside appearance by adding different colors thereto. The circuit board 30 is mounted to an upper end of the base 10 and the circuit board 30 is coupled to the base 20 through fitting or threading engagement. The circuit board 30 comprises positive and negative conductor wires 32, which extend through the centrally located through hole 23 of the base 20. The through hole 23 may alternatively or additionally accommodate other electronic components (not shown) of the LED lighting bulb. Thus, the conductor wires 32 are connected to the electrical connector 10 for electrical connection with an external power supply for receiving electrical power therefrom. The circuit board 30 carries the LEDs 31 thereon, of which the number can be plural for meeting the need of desired light source. The LEDs 31 can be mounted through SMT technology or other technologies to form the light source. The base 20 comprises a cover 40 mounted thereto. The cover 40 is made by molding a moldable material. The moldable material is preferably a plastic material or the similar materials. Further, coloring agents of different colors can be added to the moldable material in injection molding in order to make variation of colorful appearance of the base. The cover 40 and the base 20 can be coupled to each other through fitting or threading engagement so as to securely fix the cover 40 and the base 20 together. The cover 40 is made in the form of a spherical shape in order to enlarge the illumination area of the cover 40 and thus providing an improved light expansion angle. As such, advantages of light weight, reduced power consumption, excellent heat dissipation, diverse variation of multiple color, and improved operation safety can be realized.

In summary, the present invention offers the following advantages:

(1) With the improved structure of the LED lighting bulb provided herein, advantages of reduced power consumption and excellent heat dissipation can be realized and the requirement for environmental conservation and operation safety are also achieved to thereby improve the overall functionality of the present invention.

(2) With the cover and the base are both molded with moldable material, they can be changed in color in order to cooperate with the light emitting from the bulb to realize the advantages of eye catching and weight reduction to thereby enhance the overall practicability and convenience of the present invention.

What is claimed is:

1. An LED (Light-Emitting Diode) lighting bulb, comprises:
an electrical connector, which is recessed to form a hollow configuration having an intermediate section forming threading;
a base, which is formed by molding a moldable material, the base having a lower end forming a neck portion that has an outer circumferential surface forming threading for fitting to the electrical connector;
a circuit board, which is mounted to an upper end of the base and carries thereon an LED; and
a cover, which is formed by molding a moldable material and is mounted to the base.

2. The LED lighting bulb according to claim 1, wherein the moldable materials that make the cover and the fin base are colored for identification and showing.

3. The LED lighting bulb according to claim 1, wherein the moldable materials that make the cover and the base are plastic materials.

4. The LED lighting bulb according to claim 1, wherein the base forms a through hole through which conductor wires extend for electrical connection with the electrical connector.

5. The LED lighting bulb according to claim 1, wherein the base comprises a plurality of fins that is circumferentially arranged around the base.

6. The LED lighting bulb according to claim 5, wherein the fins are integrally formed.

7. The LED lighting bulb according to claim 1, wherein the cover is in the form of a spherical shape.

8. The LED lighting bulb according to claim 1, wherein the cover and the base are coupled to each other through fitting or threading engagement.

9. The LED lighting bulb according to claim 2, wherein the moldable materials that make the cover and the base are plastic materials.
